(19) United States
(12) Patent Application Publication
(10) Pub. No.: US 2008/0155844 A1
(43) Pub. Date: Jul. 3, 2008

(54) Slope measuring device and method

(76) Inventor: Jim B. Norvell, Berryton, KS (US)

Correspondence Address: INTELLECTUAL PROPERTY CENTER, LLC, 9233 WARD PARKWAY, SUITE 100, KANSAS CITY, MO, 64114, US

(21) Appl. No.: 11/646,653

(22) Filed: Dec. 28, 2006

(51) Int. Cl. G01C 9/12

(52) U.S. Cl. 33/451; 33/391; 33/521

(57) ABSTRACT

The present invention provides a slope measuring device for measuring the underlying sloped surface the device including a substantially planar surface having at least one circular opening with a graduated scale received within the circular opening, a pendulum placed between two spaced apart panels, one of which optionally including the scale. The pendulum generally includes a shaft extending laterally between the spaced panels with a pair of spacers received by the shaft at the shaft midsection with a wire extending downwardly from the shaft between the spacers and terminating at a weighted member having a pointed marker with pointed end, the pointed marker being generally adapted for placement along the graduated scale, the pointed end being associated with the measuring indicia for measuring the slope of the underlying sloped surface. Additionally, the present invention includes a method for measuring a sloped surface including the steps of providing a substantially planar surface having at least one circular aperture adapted for receipt of a pendulum sandwiched between two panels, positioning a graduated scale with plural measuring indicia along the interior perimeter of the circular opening generally at the pendulum between the panels, extending a shaft transversely between the panels, receiving a first and second spacer generally at the shaft midsection, extending a weighted member having a pointed marker from the shaft along a leader secured to the shaft between the spacers, rotating said weighted member along the scale and positioning the pointed marker along the measuring indicia to indicated the slope of the underlying sloped surface.

### FIELD OF THE INVENTION

The present invention relates generally to a method and device for measuring a sloped surface and more particularly to a new slope measuring device and method to measure slope having a pendulum rotating about a graduated scale.

### BACKGROUND OF THE INVENTION

Spirit levels have been known for many years. Such levels may have a plurality of bubble elements such that horizontal and vertical leveling measurements may be made with the same level. In such levels there may be one bubble element that is parallel to the length of the level, and another bubble element transverse to the length of the level. Additional bubble elements may be angled in various orientations to the level such as on the diagonal at 45 degrees. These levels often indicate when you have reached a predetermined orientation; however, using these spirit levels to determine the actual slope or pitch of a roof may be difficult. For instance, the bubble may expand or contract with the temperature fluctuations, also the gap which the bubble occupies does not lend itself to providing an accurate measurement. In addition, carpenters and others often refer to a roof by the degree of slope or pitch and build the structure accordingly. It therefore would be beneficial to provide a slope measuring system which indicates the slope or pitch of a roof.

Some carpenters use framing or speed squares for the construction of a building structure. These tools may provide a vertical, horizontal or diagonal straight-edge for cutting or marking a structural member. However, they typically do not provide a measurement of the slope or pitch of the structural member. In addition, while some carpentry tools may provide degree markings, these markings are only relative to a known reference such as the carpentry tools' straight edge or another nearby structural member which may or may not be properly aligned. It would therefore, be beneficial to provide a slope measuring device which provides a measurement of a sloped surface in relation to a known or fixed reference point which may be independent from a nearby building structural member.

Additionally, some carpenters utilize tables or special construction calculators or other electronic conversion accessories to determine the slope or pitch of the roof, hip or valley. However, the tables or accessories may not always be available at the job site or they may not be easy to handle while on the top of the building structure, trying to measure and cut various structural members. In addition, electronic accessories at susceptible to the ambient conditions and may fail when the batteries expire. It therefore, would be beneficial to provide a slope measurement device and method for measuring the slope or pitch of a roof, hip or valley without the need to carry along extra tables, calculators or extra conversion accessories.

### SUMMARY OF THE INVENTION

The present invention provides a slope measuring device for measuring the underlying sloped surface including a substantially planar surface having at least one circular opening with a graduated scale received within the circular opening, a pendulum placed between two spaced apart panels generally located at the graduated scale, the pendulum including a shaft extending laterally between the spaced panels with a pair of spacers received by the shaft at the scale, a wire extending downwardly from the shaft between the spacers and terminating at a weighted member having a pointed marker adapted for placement along the graduated scale for measuring the slope of the underlying sloped surface. Additionally, the present invention includes a method for measuring a sloped surface including the steps of providing a substantially planar surface having at least one circular aperture adapted for receipt of a pendulum sandwiched between two panels, positioning a graduated scale with plural measuring indicia along the interior perimeter of the circular opening generally at the pendulum between the panels, extending a shaft transversely between the panels, receiving a first and second spacer generally at the shaft midsection, extending a weighted member having a pointed marker from the shaft along a leader secured to the shaft between the spacers, rotating said weighted member along the scale and positioning the pointed marker along the measuring indicia to indicated the slope of the underlying sloped surface.

### BRIEF DESCRIPTION OF THE DRAWINGS

The drawings constitute a part of this invention and include exemplary embodiments of the present invention and illustrate various objects and features thereof.

FIG. 1 is a perspective view of the slope measuring device having at least one graduated scale with a pendulum in accordance with one aspect of the present invention.

FIG. 2 is an orthogonal view of the slope measuring device of FIG. 1 vertically aligned with a building penetration such as a window according to the present invention.

FIG. 3 is an orthogonal view of the slope measuring device of FIG. 1 positioned along a set of stairs according to the present invention.

FIG. 4 is a magnified view of one graduated scale in accordance with one aspect of the present invention.

FIG. 5 an orthogonal view of the slope measuring device of FIG. 1 positioned along a roof structure in accordance with one aspect of the present invention.

FIG. 6 is a magnified view of one graduated scale in accordance with an alternative aspect of the present invention.

FIG. 7 is a magnified view of one graduated scale in accordance with a second alternative aspect of the present invention.

FIG. 8 is a perspective view of the pendulum in accordance with one aspect of the present invention.

FIG. 9 is an exploded perspective view of the pendulum in accordance with one aspect of the present invention.

FIG. 10 is a perspective view of an alternative pendulum in accordance with one aspect of the present invention.

### DETAILED DESCRIPTION

### I. Introduction.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

### II. Slope Measuring Device.

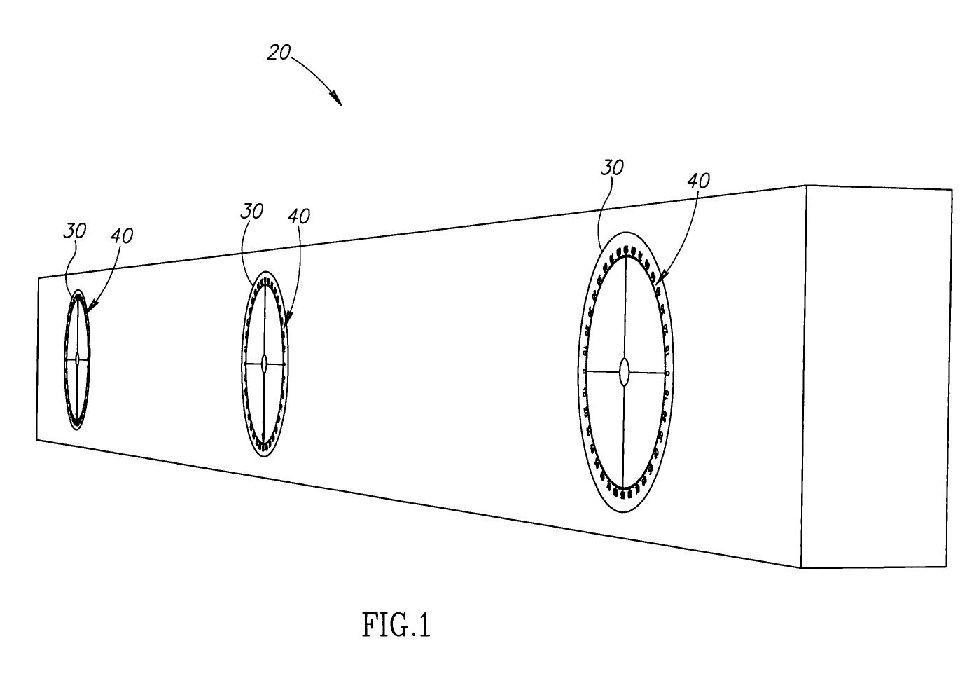

Referring to FIG. 1, an embodiment of the present invention a slope measuring device or level is generally indicated by reference numeral 20, having at least one circular opening or aperture 30 receiving a graduated scale 40 adapted for use with a pendulum 50 having a pair of spaced apart panels 52 sandwiching the scale 40. Generally the scale 40 is secured within the circular opening 30; however, the scale 40 may be adjustable. Optionally, as shown in FIG. 1, the slope measuring device may contain three (3) openings 30 within the substantially planar level 20.

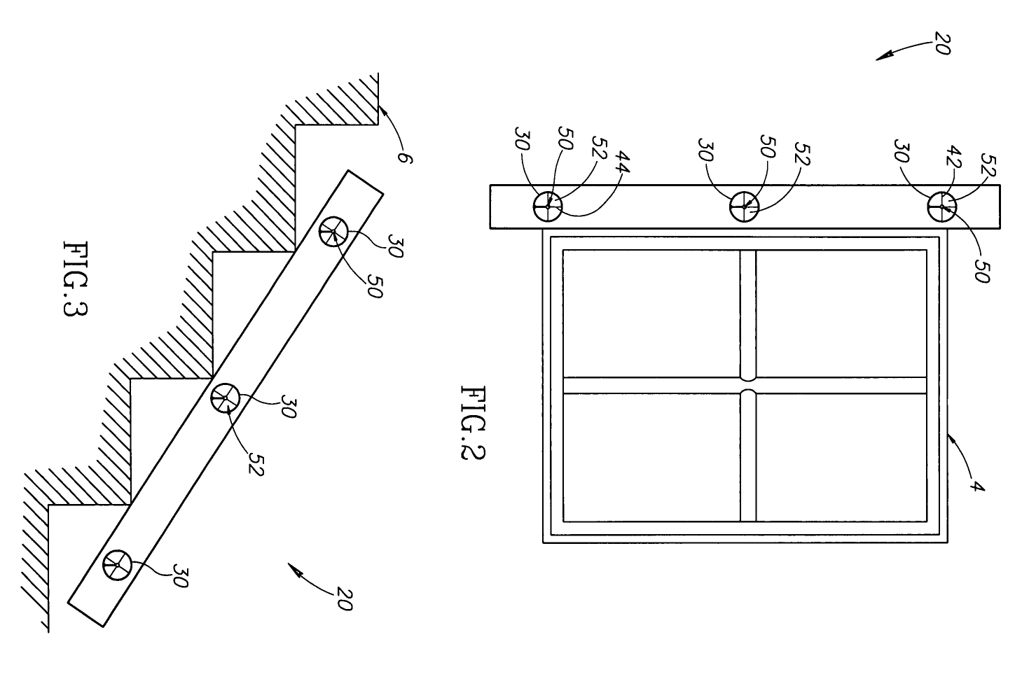

FIG. 2 illustrates the slope measuring device 20 vertically aligned with a structure such as, but not limited to, a window 4, door, chimney or other vertical or horizontal structures. As illustrated in FIG. 2, the device 20 may include three circular openings 30 each receiving pendulum 50 having at least one panel 52. When aligned with a vertical structure, the slope measuring device 20 may indicate the alignment with a pointed marker 62, associated with the pendulum 50, aligned with a vertical indicator 44. Alternatively, when the slope measuring device 20 is aligned with a horizontal surface the pointed marker 62 may be aligned with a horizontal indicator 42.

FIG. 3 illustrates the slope measuring device 20 aligned along a set of steps 6 for measure the slope of the stairs 6. Using the slope measuring device 20 for aligning vertical or horizontal structures, an architect or builder may be able to specify the angle or pitch for alignment of the various structures. Plural circular openings 30 within the apparatus 20 may allow for multiple readings at various locations along the sloped surface. Alternatively, additional slope or pitch indicators may be arranged along alternative planes to measure the slope or pitch of the structure along different dimensional axis.

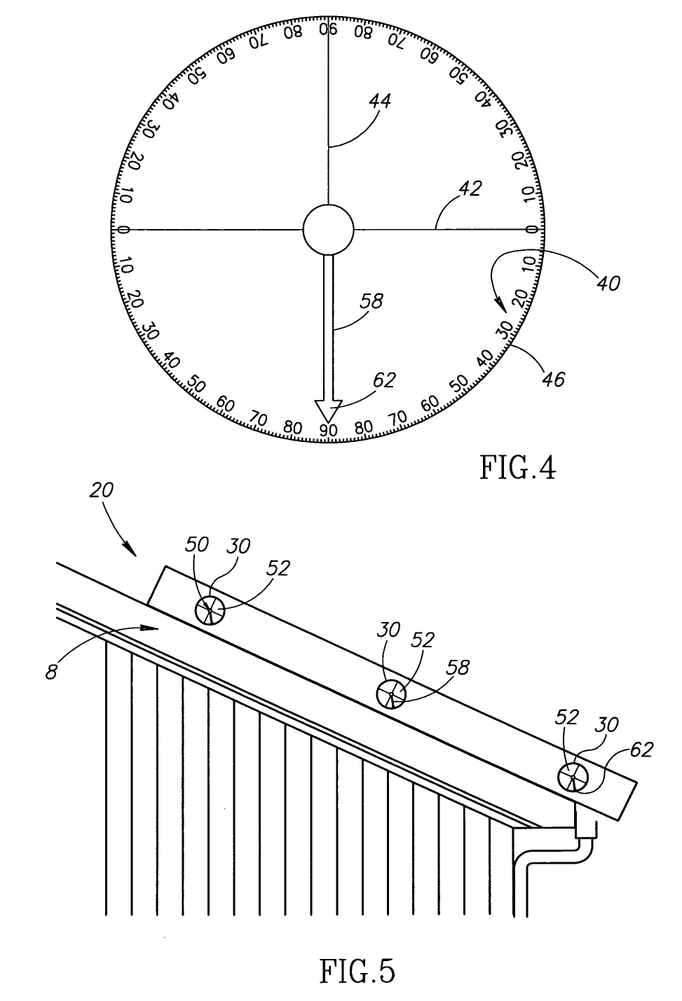

As illustrated in FIG. 4, the graduated scale 40 in addition to the horizontal indicator 42, and the vertical indicator 44, may include a number of graduated markings 46 such as angular markings separated into degrees. The graduated degree markings 46 which are regularly spaced and numbered sequentially from 0 to 90 and back to 0 for the upper portion of the circular scale 40 with the graduated degree markings 46, mirrored along the bottom portion of the circular scale 40. By providing four quadrants with a total of 360 degrees, the device 20 provides for a full range of measurement as the device 20 may be rotated about various sloped surfaces.

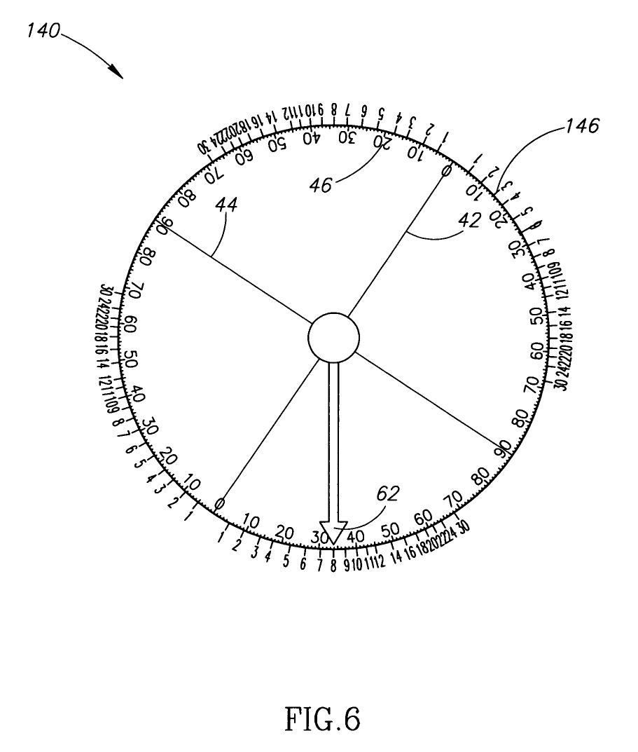

Alternatively, the slope measuring device 20 may include an alternative scale 140 for measuring the slope of an adjacent roof structure 8 as illustrated in FIG. 5. As illustrated in FIG. 6, the alternative graduated scale 140 may be provided with a plurality of alternative graduated markings or pitch markings 146 in combination with or instead of the standard degree markings 46. The alternative graduated markings 146 may indicate the roof pitch based upon the vertical distance of elevation in relation to a known horizontal distance. While standard roofs may have a unit run based upon a twelve inch run, the present invention may be used when the unit run varies from the traditional twelve inch run as further described below.

The illustrated pitch markings 146 are sequential numbered from 1 to 30 periodically spaced along the scale 140 based on the known trigonometric formula for roof pitch. The pitch markings 146 overly the graduated degree markings 46. Alternatively, the pitch markings 146 may be located adjacent to but spaced a distance from the degree markings 46 or the scale 140 may consist of plural concentric rings with one ring associated with the degree markings 46 and a second ring associated with the pitch markings 146, the rings being radially spaced apart from the center of the circular opening 30.

While the pitch of a sloped surface can vary depending on the vertical distance of the structural member per unit of horizontal distance, typical residential structures may utilize pitch markings 146 in the range of 1 to 30, as illustrated in FIG. 6. The apparatus 20, however, is not limited to this pitch range and may include other pitches, greater than 30.

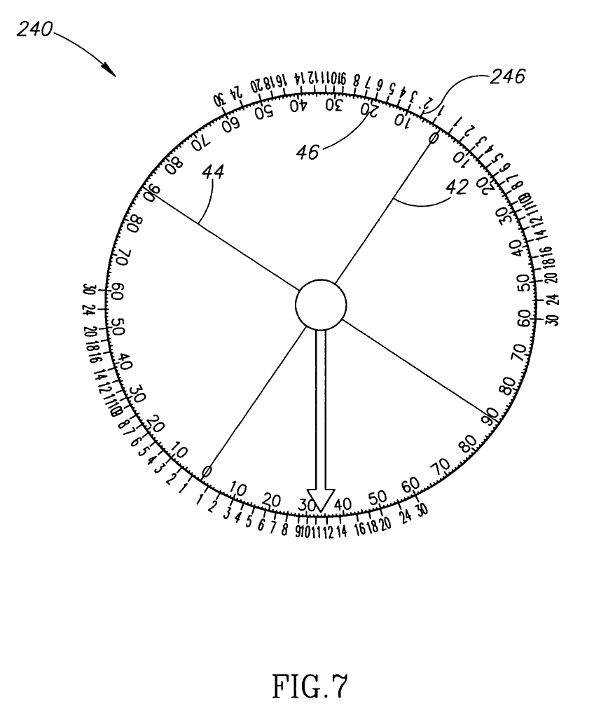

A second alternative embodiment of a scale 240, illustrated in FIG. 7, may be used to measure the slope of a hip or valley located between adjacent sloping surfaces. The scale 240 of FIG. 7 includes a plurality of hip/valley pitch markings 246 positioned along the perimeter of the scale 240 which are configured to measure the slope of the hip or valley which may be used in combination with or instead of the standard degree markings 46 or roof pitch markings 146. The alternative scale 240 maybe used for hip and valley rafters with ninety degree corners or structures which are square or rectangular which generally use a unit run of approximately 17 inches, however, the scale 240 may also be used to measure other structures such as, but not limited to, an octagonal form with a unit run of 13 inches for hips or valleys. In addition, if the degree markings 46 are used in combination with either the roof markings 146 or hip/valley pitch markings 246, the apparatus 20 can provide the measurement of the slope in terms of both pitch and degrees.

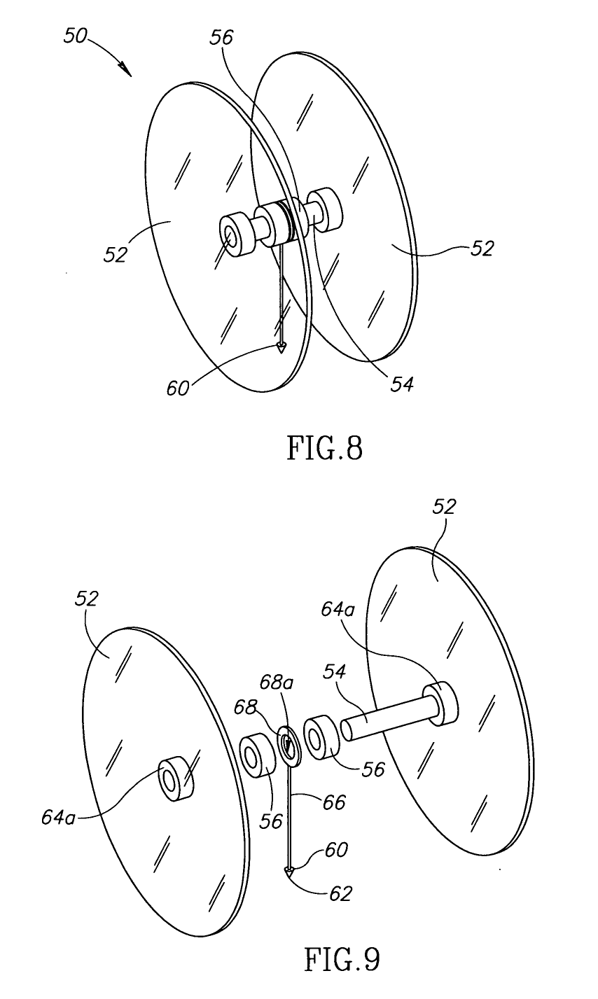

FIGS. 8-9 provide an example of the pendulum 50 with a shaft 54 extending between the panels 52 and spacers 56 positioned along the shaft 54 midsection, a weighted member 60 extending downwardly therefrom. The weighted member 60 is generally adapted for rotation about the shaft 54. The pointed marker 62 is generally associated with the weighted member 60 and may for example, but not as a limitation, include a pointed end with the marker 62 being generally secured to or included with the weighted member 60, both being fabricated from a dense material which rotates downwardly about the shaft 54 as the apparatus 20 is positioned upon the underlying sloped surface.

The panels 52 may be fabricated from a circular transparent material such as, but not limited to, glass or plastic, for reading the pointed marker 62 in relation to the scale 40. Optionally, the scale 40 with the graduated markings 46 may be superimposed upon the panels 52. Additionally, the panels 52 may be tinted or adapted for improving the visibility of the pointed marker 62 in relation to the scale 40, such as with the use of a magnifying lens or the panels 52 may simply be adapted to improve or complement the aesthetics of the apparatus 20.

The shaft 54 extends laterally through the circular opening 30 between the panels 52 and may be secured to the panels 52. Alternatively, the shaft 54 may be secured to a first and second receiver 64a, 64b, the first receiver 64a associated with the interior of one of the panels 52 and a second receiver 64b associated with the interior of the opposing panel 52. The receivers 64a, 64b are generally adapted for engagement with the shaft 54 while spacing the panels 52 a distance laterally apart through the circular opening 30. While the shaft 54 may have a number of different shapes or configurations, generally the shaft 54 provides for the rotation of the pointed marker 62 about the scale 40 as the apparatus 20 is titled upon variously configured sloped surfaces. The shaft 54 may be fabricated from a rigid material such as, but not limited to, wood, metal or plastic.

The weighted member 60 may be connected to the shaft 54 by a leader 66, such as, but not limited to, a wire, cable, rope, line or chain made from a flexible material. The leader 66 allows the weighted member 60 to extend downwardly, in a uniform direction, such as towards the ground, as the apparatus 20 is tilted by the underlying sloped surface. While the apparatus 20 may rotate upwardly or downwardly based upon the underlying contour, the weighted member 60 will remain in a consistent downward direction.

The leader 66 illustrated in FIG. 9, includes a ring 68 having a ring aperture 68a adapted to loosely receive the shaft 54, allowing the weighted member 60 to rotate about the shaft 54. Optionally, the ring 68 may include a number of friction reducing elements such as, but not limited to, bearings or lubricants which allow for less frictional rotation of the weighted member 60 about the shaft 54.

Generally, the weighted member 60 is fabricated from a dense material with sufficient quantity to exert a downward force on the leader 66 while maintaining the placement of the pointed marker 62 within the graduated scale 40. While the weighted member may temporarily move away from the scale 40 during rotation or while placing the apparatus upside down, eventually the weighted member 60 will become stationary within a certain position on the graduated scale 40 at which time the measurement of the sloped surface may be measured.

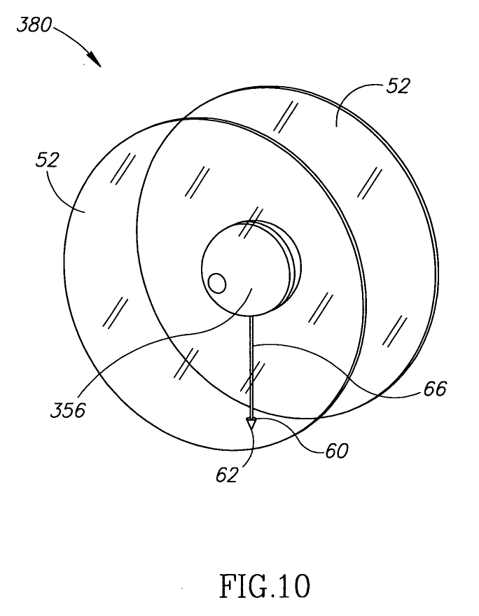

An alternative pendulum 380 is illustrated in FIG. 10 having a pair of semispherical spacers 356 positioned between the panels 52, a shaft 54 extending therebetween for receiving the leader 66 associated with the weighted member 60 and pointed marker 62. In this embodiment, the semispherical spacers 356 provide additional control of the weighted member 60 as it rotates about the shaft 54.

In operation, the scale 40 rotates as the apparatus 20 is tilted by the underlying sloped surface. As the apparatus 20 rotates, the pendulum 50 downwardly rotates the weighted mass about the shaft 54, positioning the pointed marker 62 in relation to the graduated markings 46 of the scale 40. Once the pointed marker 62 becomes stationary, the slope of the apparatus 20 may be determined by reading scale 40 at the location where the pointed marker 62 intersects the graduated markings 46 or the alternative markings 146, 246.

It will be appreciated that various other materials, configurations and embodiments may fall within the scope of the present invention. While certain forms of the present invention have been illustrated and described herein, it is not to be limited to the specific materials, forms or arrangement of parts described and shown.

1. A method for measuring an adjacent sloped surface comprising:
providing a substantially planar surface having at least one circular aperture adapted for receipt of a pendulum sandwiched between two panels;
positioning a scale with plural measuring indicia along the interior perimeter of the circular opening at the pendulum between the panels;
extending a shaft transversely between the panels;
receiving a first and second spacer generally at said shaft midsection
securing a weighted member to said shaft by a leader between said spacers,
rotating the weighted member having a pointed marker along said scale from said shaft, and
measuring the slope of the underlying sloped surface by positioning the pointed marker along said measuring indicia.

2. A slope measuring apparatus overlying an underlying sloped surface comprising:
a substantially planar structure having at least one circular opening,
a graduated scale having plural slope measuring indicia, said scale being generally received within the circular opening,
a pair of spaced apart panels sandwiching said graduated scale,
a shaft extending laterally between said spaced apart panels,
a pair of spacers received by said shaft generally at said graduated scale,
a weighted member having a rotateable mass and adapted for rotation about said shaft,
a pointed marker secured to said weighted member and having a pointed end,
a wire received by said shaft between said spacers extending from said shaft and terminating at the weighted member, and
said pointed marker being adapted for positioning along said graduated scale with said pointed end associated with said measuring indicia to indicate the slope of the underlying sloped surface.

3. The slope measuring apparatus of claim 2 wherein said panels are at least partially transparent.

4. The slope measuring apparatus of claim 2 wherein said scale includes a central aperture for receiving said shaft.

5. The slope measuring apparatus of claim 2 further comprising a pair of aligners, each associated with one of said panels, said aligners being adapted to receive said shaft.

6. The slope measuring apparatus of claim 2 wherein said transparent panels include generally vertical and horizontal indicators.

7. The slope measuring apparatus of claim 2 wherein at least one of said transparent panels is a magnifying lens.

8. The slope measuring apparatus of claim 2 wherein said graduated scale further comprises plural roof pitch indicia whereby said pointed end of said pointed marker is associated with said roof pitch indicia, indicating the slope of the underlying sloped surface.

9. The slope measuring apparatus of claim 2 wherein said graduated scale further comprises plural hip/valley pitch indicia whereby said pointed end of said pointed marker is associated with said hip/valley pitch indicia, indicating the slope of the underlying sloped surface.

10. A slope measuring apparatus for measuring the slope of an underlying roof structure having a roof pitch, comprising:
a substantially planar structure having at least one circular opening,
a pair of spaced apart panels being at least partially transparent wherein at least one of said panels includes a graduated scale having plural slope measuring indicia,
said panels being generally received within the circular opening,
a shaft extending laterally between said spaced apart panels,
a pair of spacers received at said shaft midsection,
a weighted member having a rotateable mass and adapted for rotation about said shaft,
a pointed marker secured to said weighted member terminating at a pointed end,
a wire received between said spacers, extending from said shaft and terminating at the weighted member, and
said pointed marker being positioned along said graduated scale with said pointed end associated with said measuring indicia, indicating the slope of the underlying roof structure.

11. The slope measuring apparatus of claim 10 further comprising a pair of aligners, each associated with one of said panels, said aligners being adapted to receive said shaft between said panels.

12. The slope measuring apparatus of claim 11 wherein said aligner is generally semispherical.

13. The slope measuring apparatus of claim 10 wherein said panels include vertical and horizontal indicators.

14. A slope measuring apparatus for measuring the slope of an underlying roof structure having a hip/valley pitch, comprising:
a substantially planar structure having at least one circular opening,
a pair of spaced apart panels being at least partially transparent wherein at least one of said panels includes a graduated scale having plural slope measuring indicia,
said panels being generally received within the circular opening,
a shaft extending laterally between said spaced apart panels,
a pair of spacers received at said shaft midsection,
a weighted member having a rotateable mass and adapted for rotation about said shaft,
a pointed marker secured to said weighted member terminating at a pointed end,
a wire received between said spacers, extending from said shaft and terminating at the weighted member, and
said pointed marker being positioned along said graduated scale with said pointed end associated with said measuring indicia, indicating the hip/valley pitch of the underlying roof structure.
